(19) United States
(12) Patent Application Publication
(10) Pub. No.: US 2015/0183203 A1
(43) Pub. Date: Jul. 2, 2015

(54) Compound Membrane and Method for Manufacturing Same

(71) Applicant: Bingke Zhu, Shenzhen (CN)

(72) Inventor: Bingke Zhu, Shenzhen (CN)

(73) Assignee: AAC TECHNOLOGIES PTE. LTD., Singapore city (SG)

(21) Appl. No.: 14/295,842

(22) Filed: Jun. 4, 2014

(30) Foreign Application Priority Data
Dec. 27, 2013 (CN) 201310739464.X

(51) Int. Cl. B32B 37/18; B32B 38/00; G10K 13/00; B32B 27/06; B32B 27/28

(52) U.S. Cl. CPC B32B 37/182; B32B 27/06; B32B 27/288; G10K 13/00; B32B 38/0008; B32B 2250/02

(57) ABSTRACT

A compound membrane includes a silicon-based layer and a polyetheretherketone layer heat compressed with the silicon-based layer. A method for manufacturing the compound membrane includes a the steps of providing a silicon-based layer, applying plasma treatment to the silicon-based layer, activating the upper surface of the silicon-based layer, providing a PEEK layer, and compounding the silicon-based layer and the PEEK layer by heat compression. The compound membrane of the present disclosure has the characters of high thermo-stability, great stability, and improved strength.

### FIELD OF THE INVENTION

The present invention relates to compound membranes, more particularly to a method for manufacturing a compound membrane used in a speaker.

### DESCRIPTION OF RELATED ART

Typically, a membrane is formed by a single film or by hot pressing a piece of thermoplastic material, but the rigidity of the membrane is not enough when vibrating. In addition, to increase the rigidity of the membrane, the usual method is to increase the thickness of the membrane. However, a membrane is formed by a single film, whose thickness of different portion are the same, as a result, the sound quality of the acoustic device is undesirable when the membrane vibrates.

Some of the speakers often comprise compound membranes which are basically a combination of layers of different materials or just a mixture of different materials.

JP 04-042699 discloses a diaphragm for a speaker made of a composite material being a composition of a thermoplastic synthetic resin fiber having a high glass transition temperature with a thermoplastic synthetic resin fiber having a low glass transition temperature being raw materials of two kinds of thermoplastic synthetic resin fibers having different glass transition temperatures heated at the forming. That is, the glass transition temperature of the composite takes a value between the individual glass temperatures and a large internal loss shall be obtained with a wider temperature range in comparison with the case with complete mixture of the two kinds of synthetic resins. However, conventional acoustic devices suffer from a non-sufficient lifetime.

Accordingly, an improved compound membrane which can overcome the disadvantage described above is desired.

### BRIEF DESCRIPTION OF THE DRAWINGS

Many aspects of the embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an illustrative cross-sectional view of a compound membrane in accordance with an exemplary embodiment of the present disclosure.

FIG. 2 is a flow chart of a method for manufacturing the compound membrane in FIG. 1.

### DETAILED DESCRIPTION OF THE EXEMPLARY EMBODIMENT

The present invention will hereinafter be described in detail with reference to an exemplary embodiment.

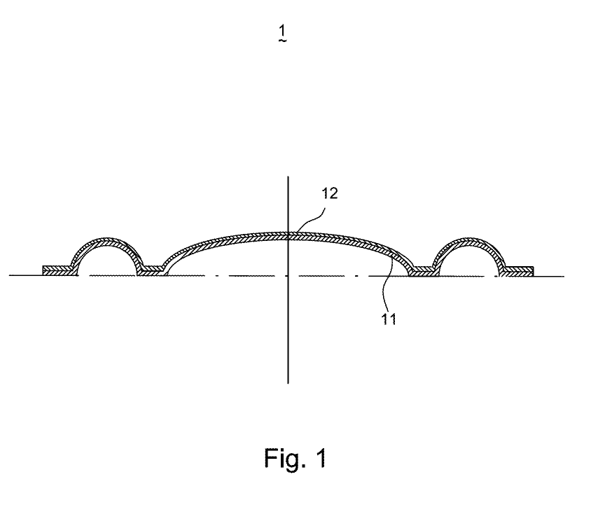

Referring to FIG. 1, which is an illustrative cross-sectional view of a compound membrane 1 in accordance with an exemplary embodiment of the present disclosure, the compound membrane 1 includes a silicon-based layer 11, and a polyetheretherketone (PEEK) layer 12 coupled with an upper surface of the silicon-based layer 11.

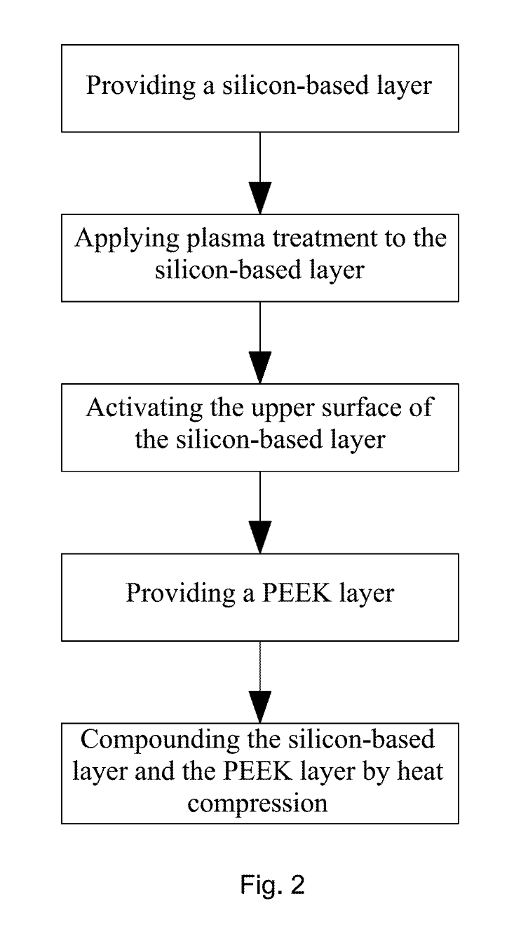

Referring to FIG. 2, which is a flow chart of a method for manufacturing the compound membrane 11 described above. The method comprises the steps of:

Providing a silicon-based layer 11;

Applying plasma treatment to the silicon-based layer 11;

Activating the upper surface of the silicon-based layer 11;

Providing a PEEK layer 12;

Compounding the silicon-based layer 11 and the PEEK layer 12 by heat compression.

Peek and silicon both have high thermo-stabilities (high temperature resistance), and coefficients of expansion thereof are similar to each other, so, it is not difficult to couple the two layers by heat compression. Therefore, the compound membrane 1 formed by a silicon-based layer 11 and a PEEK layer 12 has the characters of high thermo-stability, great stability, and improved strength. Speakers using this kind of compound membrane have improved acoustic performance. It is understood that each of the steps is not restricted to the description order, and the steps can be realized at a reasonable sequence.

Plasma treatments are becoming increasingly employed for surface activation in various wafer and direct bonding applications. The technology is based on the principle of dielectric barrier discharge. To achieve uniform plasma discharge, two electrodes are required, at least one of which has to have a sufficiently thick dielectric layer, and the intermediate gap has to be sufficiently small. When alternating voltage is applied, a uniform discharge ensues even under atmospheric pressure, making the use of costly vacuum technology obsolete.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A compound membrane, comprising:
a silicon-based layer;
a polyetheretherketone layer heat compressed with the silicon-based layer.

2. A method for manufacturing the compound membrane as claimed in claim 1 comprising the steps of:
providing a silicon-based layer;
applying plasma treatment to the silicon-based layer;
activating the upper surface of the silicon-based layer;
providing a PEEK layer;
compounding the silicon-based layer and the PEEK layer by heat compression.
